(19) United States
(12) Patent Application Publication
(10) Pub. No.: US 2003/0112273 A1
(43) Pub. Date: Jun. 19, 2003

(54) Document collaboration suite using a common database

(75) Inventors: Barrie Alan Hadfield, Blackheath (GB); Robin Wallace Glover, Didcot (GB); Stephen John Coates, London (GB); Steve Hopkins, Kent (GB)

Correspondence Address: COUDERT BROTHERS LLP, Third Floor, 600 Beach Street, San Francisco, CA, 94109, US

(73) Assignee: Workshare Technology, Ltd.

(21) Appl. No.: 10/136,733

(22) Filed: Apr. 30, 2002

Related U.S. Application Data
(63) Continuation-in-part of application No. 10/023,010, filed on Dec. 17, 2001.
(60) Provisional application No. 60/341,935, filed on Dec. 18, 2001.

(51) Int. Cl. G09G 5/00

(52) U.S. Cl. 345/751; 345/759

(57) ABSTRACT

A system and method is provided for document collaboration between a managing author using a document management system (DMS), and one or more contributing authors. The system includes: a common storage area coupled to a plurality of user computer systems via a communications network; manager software stored on a first user computer system, where the manager software exclusively controls change to a document stored in the common storage area; and contributor software stored on a second user computer system, where the contributor software provides a proposed change to a replica of the document stored in the common storage area.

### CROSS REFERENCES

This application is a continuation-in-part of and claims priority to, U.S. patent application Ser. No. 10/023,010, titled “Method and System For Document Collaboration,” filed Dec. 17, 2001 which is incorporated by reference herein.

This application claims priority to U.S. Provisional Application Serial No. 60/341,935, titled “Document Collaboration Suite Using a Common Database,” filed Dec. 18, 2001, which is incorporated by reference herein.

### FIELD OF THE INVENTION

The invention relates generally to the field of document collaboration, and in particular to a method and system for document collaboration over a communications network.

### BACKGROUND OF THE INVENTION

Document management systems (DMSs) have typically provided the infrastructure for document collaboration between professionals, particularly in corporations and the legal industry, and in other areas where a managing author, who maybe the originating author, of a document needs to keep control over the evolution of the document, e.g., from original document to final document. In recent years, document management systems have been extending their functionality to encompass even more aspects of document collaboration, for example, including a workflow system to notify collaborators of the progress of work on any given document. Nevertheless, despite this progress, document management systems do not provide for incorporating the individual changes proposed by different collaborators into the managing author's document. This means that if person A wishes to have a document reviewed by persons B and C, once persons B and C have reviewed the document and suggested changes to it, person A is still left with the problem of incorporating those changes into the original document.

### SUMMARY OF THE INVENTION

The present invention provides a system and method for document collaboration between a managing author and one or more contributing authors using a document management system (or local file system). The present invention formalizes the roles of the individuals involved in the collaboration involved in working on a document. A contributor (i.e., “author”) may have one of two roles per a collaboration: managing author or contributing author. A managing author is responsible for the collaboration on an original document, and has sole control over which suggested modifications offered by the contributing authors are incorporated into the final document. While the contributing authors are able to edit and otherwise change a replica of the original document, the present invention treats the changes made by contributing authors as only suggestions or proposed changes to a document. “Editing,” as used herein, comprises: revising, commenting, redlining, or changing a document or any combination thereof.

A collaboration starts with an original document, which includes any document selected by the managing author, and goes through revisions under control of the managing author, until a final document is obtained. Each revision may include proposed changes from responses from contributing authors.

One embodiment of the present invention comprises a method, using a computer system for collaboration on a document stored in at least one computer readable medium, between a managing author and at least one contributing author. First, access rights are assigned to the document by the managing author using the DMS, where the access rights exclusively control changes to the document. Next, a replica of the document is created using the computer system and is provided to each contributing author for review and editing. After each contributing author edits his/her replica, the managing author reviews the edits. If the managing author accepts a change due to an edit, the change is incorporated into the document.

In another aspect of the present invention the computer system comprises a plurality of individual computers or computer terminals linked via a communications network, such as a local area network, a wide area network, the internet or combinations thereof. The system includes: a common storage area coupled to the plurality of user computers via the communications network; manager software stored on a first user computer of the plurality of user computer systems, where the manager software exclusively controls change to a document stored in the common storage area; and contributor software stored on a second user computer of the plurality of user computer systems, where the contributor software provides a proposed change to a replica of the document stored in the common storage area.

One aspect of the present invention comprises a method for document collaboration utilizing a contributor computer and a manager computer connected together via a network. First, the contributor computer receives a replica of a document sent by the manager computer. The replica and the document are stored in a common database. Next, a proposed change is generated by editing the replica. And the contributor computer displays a portion of the document having the proposed change, after the proposed change is incorporated by the manager computer into the document.

An embodiment of the present invention comprises a method for document collaboration using a plurality of contributing computers and a managing computer, the manager computer controlling changes to a document. A part of a first replica of the document is displayed by a first computer of the plurality of contributing computers. And concurrently with displaying the part of the first replica, the first computer displays a part of a second replica of the document, wherein the second replica includes a change to the document by a second computer of the plurality of contributing computers.

Another aspect of the present invention comprises a system for document collaboration comprising a computer storage area and a software application stored in a computer readable medium, that executes on a computer connected to the computer storage area, where the software application includes a manager mode for controlling changes to a document stored in the computer storage area and a contributor mode for providing proposed changes to a replica of the document stored in the computer storage area.

Another embodiment of the present invention comprises a system for document collaboration using at least a first contributing computer, a second contributing computer and a managing computer. The system comprises: a database coupled to at least the second contributing computer, where the database stores a document, a first replica of the document, and a second replica of the document, and wherein the first replica has an edit from the first contributing computer; and a display of the second contributing computer has a first window having the edit and a second window having a part of the second replica.

Another aspect of the present invention comprises a system for document collaboration between a managing author and at least one contributing author. The system comprises an application program stored in a computer readable medium and a database. The application program is used to create a replica of an original document, for use by the contributing author; to receive a response having proposed changes to the replica from the contributing author; and to incorporate the proposed changes into the original document, when accepted by the managing author. The database is used to connect to the computer readable medium, and to store the original document, the replica, and the response.

Yet another aspect of the present invention comprises a data structure stored in a computer readable medium for maintaining proposed and accepted changes to an original document in a document collaboration between a managing author and one or more contributing authors. The data structure comprises a document object associated with the original document; a revisions collection object associated with the document object, where the revisions collection object has one or more revision objects, and wherein a revision object has a revision sent to a contributing author for review; and a responses collection object associated with the revision object, where the responses collection object has zero or more response objects, and wherein a response object has a response having proposed changes to the revision from the contributing author.

A further aspect of the present invention comprises a method for collaboration between a plurality of contributing authors and a managing author using a common database. The managing author provides a document for review by the plurality of contributing authors. Next, a first contributing author of the plurality of contributing authors stores a first proposed change to the document in the common database and a second contributing author of the plurality of contributing authors stores a second proposed change to the document in the common database. Then on a display used by the first contributing author, the second proposed change is displayed, and on a display used by the second contributing author, the first proposed change is displayed.

An embodiment of the present invention comprises a computer-readable medium containing instructions for causing a computer system to provide an application with an interface for manipulating objects in a database, where the database is used for document collaboration. The instructions comprises adding a revision object when a document is added to the document collaboration; distributing for review by a contributing author a replica of the document; and associating a response object with the revision object based on a response received from the contributing author.

These and other embodiments, features, aspects and advantages of the invention will become better understood with regard to the following description, appended claims and accompanying drawings.

### BRIEF DESCRIPTION OF THE DRAWINGS

FIG. 1 shows a schematic block diagram of a document collaboration system;

FIG. 2 is simplified block diagram of the document collaboration system of one embodiment of the present invention;

FIG. 3 is an example of the collaboration process performed on an original document;

FIG. 4 is a flowchart of the collaboration between a managing author and an internal contributing author of an embodiment of the present invention;

FIG. 5 is an example of a manager graphical user interface (“GUI”) of one embodiment of the present invention;

FIG. 6 is an example of a internal contributor GUI of one embodiment of the present invention;

FIG. 7 is another aspect of the internal contributor GUI of FIG. 6;

FIG. 8 is another example of a internal contributor GUI;

FIG. 9 is simplified block diagram of the document collaboration system of another embodiment of the present invention;

FIG. 10 is an object model of an embodiment of the present invention.

### DETAILED DESCRIPTION OF THE INVENTION

In the following description, numerous specific details are set forth to provide a more thorough description of the specific embodiments of the invention. It is apparent, however, to one skilled in the art, that the invention may be practiced without all the specific details given below. In other instances, well known features have not been described in detail so as not to obscure the invention.

In an embodiment of the present invention there are roles assigned to each person in a document collaboration. A person for a collaboration may have either a manager role as a managing author or a contributor role as a contributing author, but not both at the same time on the same document. A person may open the document in manager mode or contributor mode, but not both. When the person opens the document in manager mode, the document is locked, so that there is only one manager role. However, when the person closes the document, another person can open the document in manager mode. Thus control, i.e., the manager role, can be passed to separate individuals. For example, an individual may create and circulate an initial draft of a document as a manager and then have a secretary or other assistant take over the subsequent management of the document.. In addition a person may have different roles at the same time on different documents, for example, a person may be a managing author on document A and at the same time a contributing author on document B.

The assignment of roles to individuals is a major difference between the present invention and typical word processors, for example, Microsoft® Word. In typical word processing software there are no defined roles, and hence any individual can control the contents of the document. Without a central controlling author, the collaboration process may become chaotic and difficult to manage.. Hence roles provide an ordered collaboration process.

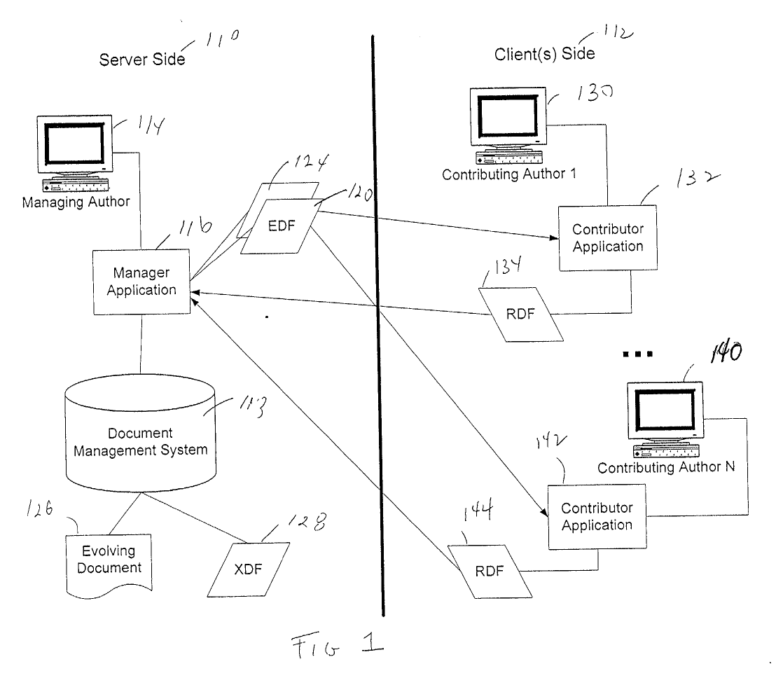

FIG. 1 shows a schematic block diagram of a document collaboration system. The Server side 110 includes the managing author's computer 114 which is coupled to a first server computer (not shown) executing the Manager Application 116. In one aspect the managing author's computer 114 and the first server computer are the same. In an alternative aspect the managing author's computer 114 and the first server computer are different computers. The first server computer is connected to a second server computer (not shown). The Document Management System (DMS) 118 executes on the second server computer. In yet another aspect the DMS runs on the first server computer and there is no second server computer. The DMS 118, stores the evolving document 126, which includes the original document and proposed changes accepted by the managing author, and an eXtended Document Format (XDF) 128 file, that includes revisions and proposed changes to the revisions. In a further aspect the local file system is used instead of DMS 118 and the evolving document 126 and XDF are stored in the local file system. Client side 112 includes one or more contributing author's computers, for example, contributing author l's computer 130 to contributing author N's computer 140.

In FIG. 1, the managing author's computer 114 accesses the manager application 116 to first select an original document, e.g., a Microsoft® Word Document, which is stored in the DMS 118 as the evolving document 126. Then the manager application 116 produces one or more replicas of the original document. Each replica is put in an Enhanced Document Format (EDF) file, e.g., 120 and 124. The manager application 116 then sends, e.g., by email, an EDF file 120 to a contributor application 142 running on contributing author's computer 140. Another EDF file 124 may be sent, e.g., by email, to another contributor application 132 running on the contributing author's computer 130. The contributing authors edit their respective replicas and return, e.g., by email, the proposed changes via response document format (RDF) files, e.g., 134 and 144, to the manager application 116. The manager application 116 extracts the proposed changes to the original document and displays them to the managing author 114. The managing author 114 selects none, some, or all of the proposed changes to the original document, and these are incorporated into the evolving document 126, i.e., the original document is modified with the accepted changes.

According to a preferred embodiment of the present invention, internal contributing authors have access to the same database as the managing author, and the XDF file is replaced with separate revision and response files that are stored and maintained in the DMS or a separate object store, e.g., a Collaboration Server database.

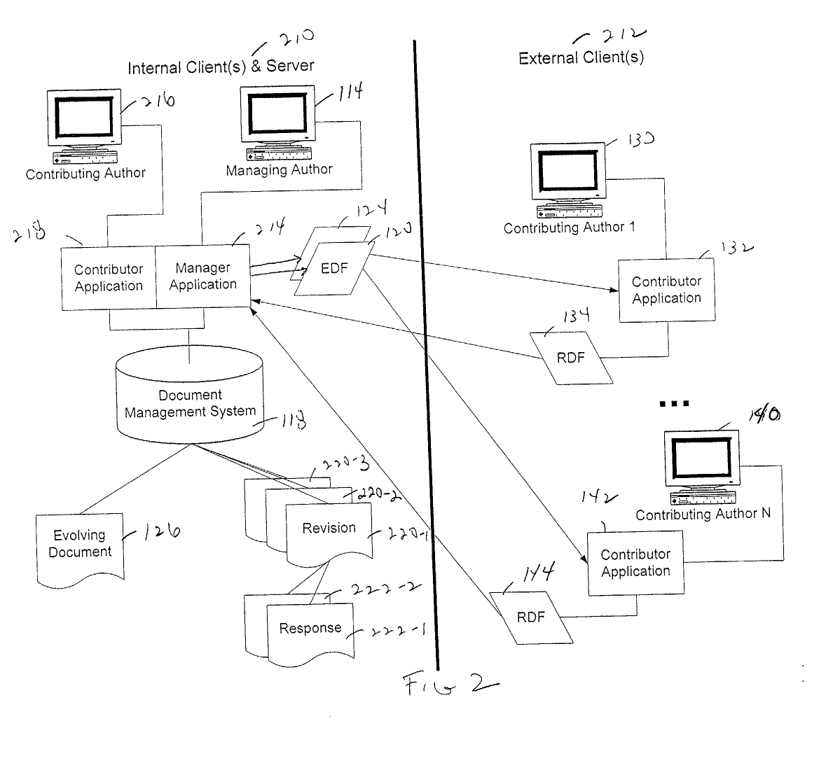

FIG. 2 is simplified block diagram of the document collaboration system of one embodiment of the present invention. FIG. 2 is similar to FIG. 1 in that the managing author 114 through a manager application 214 selects the evolving document 126, that begins as the original document, in the DMS 118 for review by external clients 212, e.g., contributing author 130 to contributing author 140. These external clients 212 are computers which are, for example, outside the firewall or not part of the company's intranet (where an intranet is a secure, private network not accessible by the public and where the private network may include a local area network, a wide area network, a virtual private network, or combinations thereof). The external clients 212 do not have access to the DMS 118 that the managing author 114 is using. The manager application 214 creates a replica of the evolving document 126 for each contributing author and sends the replicas using an EDF, e.g., EDF 120 and 124, to contributor applications 142 and 132, respectively. The contributing authors edit their replicas and send their proposed changes via RDF files 134 and 144, respectively, back to the manager application 214. The managing author 114 then accepts or rejects the proposed changes from the contributing authors. The accepted changes modify the original document contents in the evolving document 126. If the managing author 114 wants further review of the modified evolving document 126, i.e., a second revision, then this second revision is replicated and the replicas are sent (via new EDFs) to the contributing authors for another review. The various revisions, e.g., 220-1, 220-2, and 220-3, of the original document, along with their corresponding responses, e.g., for revision 220-1 corresponding responses 222-1 and 222-2, are stored in the DMS 118. These revision and response files have replaced the XDF file 128 of FIG. 1.

Pursuant to one embodiment of the present invention, the ability of contributing author(s) to edit the EDF replica(s) may be restricted by the managing author by selecting one or more of the editing privileges. The default is full editing rights. Exemplary options of editing privileges include: protected (no copy out or print), were the contributing author(s), can only copy out of or paste into the replica, items in the replica itself, cannot print the replica, and cannot save the replica in other than EDF format; lock text (comment only), were the contributing author(s) cannot edit the replica(s) (they may only add comments); and set expiration date and time, where the contents of the EDF are not readable, i.e., the file cannot be opened, after a certain date and/or time. Preferably, contributing authors are informed of their restrictive editing privileges in the body text of the e-mail they receive.

In one embodiment of the present invention restrictive editing rights for the EDF files may be applied to one or more sections of the document with the remaining sections having full editing rights. For example, a contributing author may be allowed to only edit one clause in a contract or to comment upon only two paragraphs in a document.

FIG. 2 unlike FIG. 1 includes one or more internal contributing authors, e.g., contributing author 216 connected to contributor application 218. These internal contributing authors have access to the same DMS 118 as the managing author 114. Typically the internal contributing authors and the managing author are on the same intranet or virtual private network (VPN). In one embodiment of the present invention there are two executable files (i.e., software applications), a first executable file for the manager and internal contributors, i.e., the manager application 214 and the contributor application 218 are in one executable file and a second executable file for the external contributor application, e.g., 132 or 142. The first executable file can be opened in either Manager Mode or (Internal) Contributor Mode. This first executable file interfaces directly to the DMS 118 which stores both the internal contributors' and manager's files. Both the manager application 214 and the contributor application 218 have access to the DMS 118. In an alternative embodiment the (internal) contributor application 218 and the manager application 214 are in separate executable files rather than being combined into one.

Both the first and second executable files further include the EDF editor. For an external contributor the second executable, having the EDF editor, allows users who do not have access to the DMS, e.g., those outside of a corporate firewall, to participate. In order to allow such a user to work on the collaboration having a first original document, a first managing author using the first executable file in the manager mode sends an EDF document (having a replica of the first original document) to an external contributor. The contributing author then edits the file and submits an RDF, having the proposed changes, to the first executable file for incorporation into the DMS. The first executable file also includes the functionality of the EDF Editor, so that if a second managing author (i.e., a managing author of a second original document) sends an EDF document (having a replica of the second original document) to the first managing author with the above first executable file (but without access to the second managing author's DMS), the first managing author can edit the replica of the second original document without needing to install the EDF Editor.

The (internal) contributor mode allows an internal contributing author to interact with the managing author and the other internal contributing authors dynamically without using the EDF and RDF files, because of the common access to the files stored in the DMS.

In accordance with an embodiment of the present invention, local contributors have common access to an object-oriented database or local file system. The access to a shared storage area is the major aspect of the present invention, not the type of storage used, e.g., relational database, objected oriented database, flat file, DMS. Thus embodiments of the present invention apply to any type of shared storage. In the internal contributor mode, a contributing author opens a replica of a document stored in the DMS and edits the replica. The replica is also stored in the DMS. At any time the contributing author may make a “Save as Draft” of his/her work. This saves the current edited replica as a draft (DFT) file in the DMS, so that the contributing author, for example, can return to continue editing the draft in the future. When the contributing author is ready to submit the proposed changes, he/she selects “Submit Changes and Exit” from a dialog box. Whereas an external contributor's submits an RDF file (which includes an encrypted difference file and encrypted XML metadata), an internal contributor submits this data as a response or “RSP” file. This RSP file is stored in the DMS, associated with the appropriate revision or REV file. In an alternative embodiment the REV and RSP files are stored on the local file system.

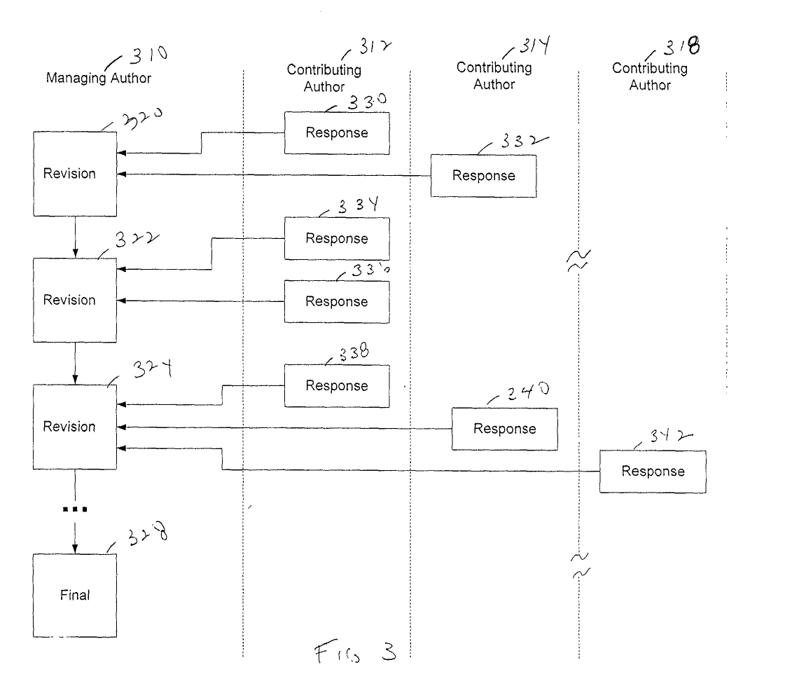

FIG. 3 is an example of the collaboration process performed on an original document of an embodiment of the present invention. The managing author 310 selects an original document (not shown) from the DMS and requests edits or comments from N contributing authors, for example, contributing authors 312, 314, 318, where N is a natural number. The original document becomes revision 320, when the managing author requests at least one contributing author for review, e.g., for edits and/or comments. The managing author 310 has control of who can access the replicas of the original document for editing, commenting, or a combination thereof, by using the DMS. Hence, for example, managing author can restrict access by allowing only contributing authors 312 and 314 to edit (and/or comment) on revision 320, and allow only contributing author 312 to edit revision 322. Contributing author 312 edits (or make comments to) a replica of the original document and sends back a response 330. Contributing author 314 edits (or make comments to) another replica of the original document and sends back a response 332. The managing author 310 then reviews and accepts or rejects the proposed changes by the contributing authors 312 and 314 to revision 320. The modified revision 320 becomes revision 322. If the managing author 310 is satisfied with the changes, then revision 322 is the final document 328 and the collaboration process is finished. If the managing author decides on another round of review, then revision 322 is sent to the contributing authors, e.g., contributing author 312 for edits/comments. Contributing author 312 edits a replica of revision 322 and sends back response 334. Then contributing author 312 edits the replica again and sends back a second response 336. The managing author then reviews and accepts or rejects changes from each response to revision 322. Again revision 322 becomes the final document 328, if the managing author 310 is satisfied. Otherwise the managing author 310 may request another round of review and modified revision 322 becomes a revision 324 for review by the contributing authors. For revision 324 contributing authors 312, 314, and 318 edit replicas of the revision 324 document and send responses 338, 340, and 342, respectively back to the managing author 310, and so forth until a final document 328 is produced.

In a preferred embodiment of the present invention the revision and response data is stored in the DMS, object database, or local file system as a series of files rather than in the XDF file. The relationships between the series of files is based on the evolution of an original document as described above in FIG. 3. There are a series of revision files, e.g., revision 320, revision 322, revision 324, where each revision file has a series of response files associated with it, e.g., revision 320 has responses 330 and 332 associated with it. Thus either the DMS relationship mechanism or a separate function based on the above, maintains the relationships of the revision files and the response files. The revision and associated response files form an audit trail by which all changes to an original document can be tracked.

Thus the structure of files held within the DMS includes each document having a collaboration associated with it. In each collaboration, there may be zero or more revisions. For each revision there are zero or more responses. And for each response there are zero or more drafts.

The revision file includes information about the version or revision of the evolving document and its location. This file takes the form of a “.REV” file. The REV file includes “Distributed Data” which includes the compressed word processing document that was put in the EDF (which includes the unedited replica). The REV file further includes “Revision Properties” which include compressed eXtended Markup Language (XML) data including the title of the revision, date, time, etc.

The response file has information about the changes and comments that have been made by one contributing author to a revision of the reviewed document and shows the name of the contributing author that responded. This file takes the form of a “.RSP” file. The RSP file includes: “Redline Data,” which is attached to each response and contains the “redline” document shown in the tab view of the manager for that response, in compressed RTF format; “Change Data,” which is also attached to each response and includes a compressed XML stream which describes all the changes in that response; “Change Data Status,” which is compressed XML data describing the status of each change; and “Response Properties,” which is compressed XML data including the title of the response, date, time, etc.

For an internal contributor the edited replica he/she produces is stored in the DMS and used by a comparison tool such as WORKSHARE® DELTAVIEW® from Workshare Technology Ltd. of London, U.K., along with the unedited replica to produce the redline RTF and the change data XML files.

For an external contributor a RDF, having a binary difference file, is received by the managing author. The unedited replica is used with the binary difference file to reproduce the edited replica. A comparison tool then uses the edited replica along with the unedited replica to produce the redline RTF and change data XML files.

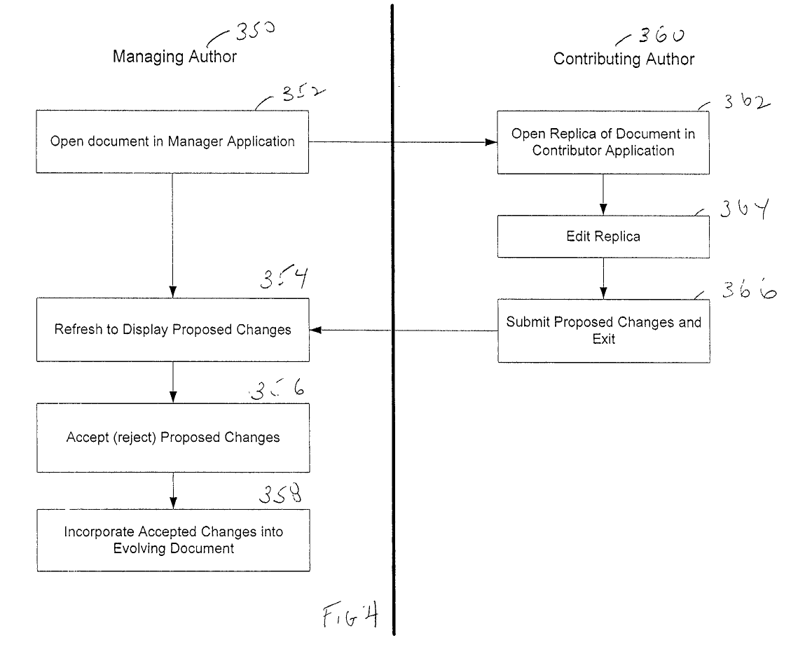

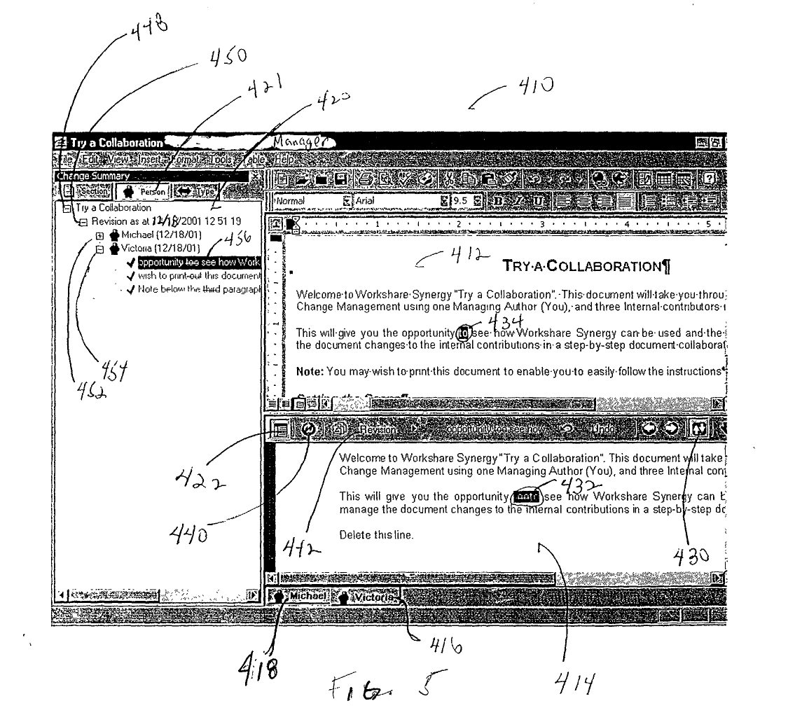

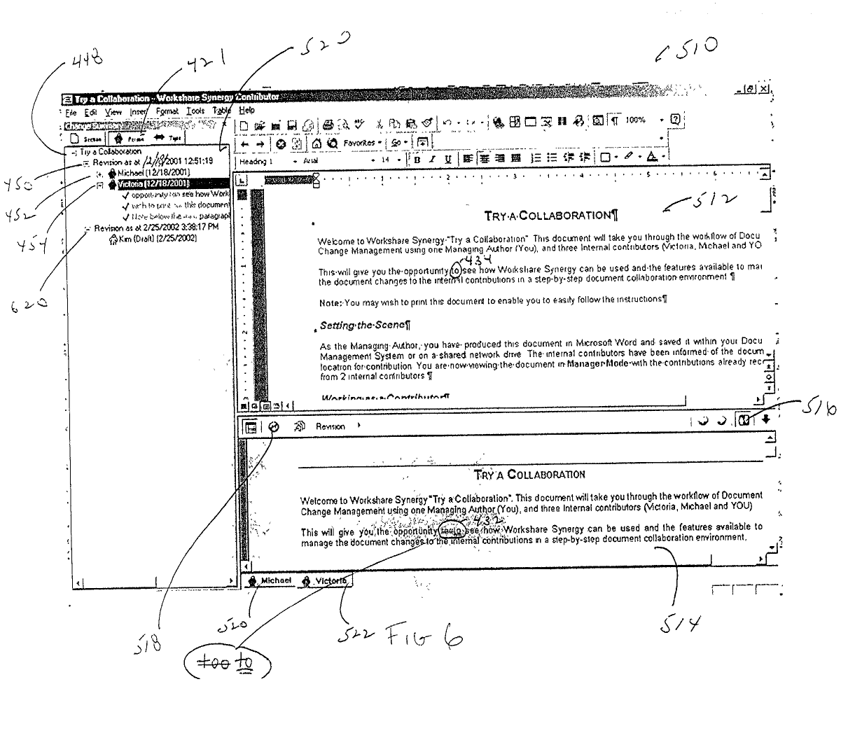

FIG. 4 is a flowchart of the collaboration between a managing author 350 and an internal contributing author 360 of an embodiment of the present invention. At step 352 a word processing document, e.g., evolving document 126, stored in the DMS 118, is opened by a manager application 214 and is displayed in a manager mode graphical user interface (GUI), e.g., FIG. 5. At step 362, when the contributing author 360 tries to open the same word processing document, the contributing author is only allowed to open a replica using the contributor application 218 that displays a contributor mode GUI, e.g. FIG. 6. Whether an individual user can open the word processing document in manager or contributor mode, is dependent on the user's editing rights inside the DMS. Normally, an internal contributing author has no editing rights to the original document or its various revisions. Only the manager has editing rights to the original document and its various revisions.

Both the managing author 350 and the (internal) contributing author 360 have direct access to the DMS 118, and their files are stored in the DMS 118. Any proposed changes by the contributing author 360 and any accepted changes by the managing author 350 are maintained in the DMS 118. The proposed changes to a revision file by a contributing author are in his/her response file, where both the revision file and the response file are stored in the DMS.

At step 364 the contributing author 360 edits the replica and then submits the proposed changes to the DMS 118 and exits (step 366). The contributing author has the option of saving a draft of his/her edits in order to save a temporary back-up copy or to continue work later on. When the draft is finished it can then be submitted to the managing author as the contributing author's response.

In one embodiment, after the contributing author's response is stored in the DMS 118, the managing author 350 manually selects on the manager mode GUI a refresh button to display the contributing author's proposed changes in the form of a document with mark ups (step 354).

In an alternative embodiment the manager mode GUI is automatically updated with the contributing author's proposed changes. At step 356 the managing author 350 accepts or rejects each of the proposed changes from each contributing author. As the managing author accepts the changes, the accepted changes are incorporated into the evolving document 126 (step 358).

If a user is a managing author, then he/she may also send an EDF file 130, having a replica of the word processing document, to an external contributor, who displays the EDF file using an EDF editor GUI. Typically the external contributor is a user without direct access to the DMS for the collaboration, and receives the EDF, e.g., by email or by downloading from a server. The external contributor edits the replica and returns proposed changes and comments in an RDF file by, e.g., email, to the managing author. The manager application 214 puts the RDF information into the DMS 118. The managing author then accepts or rejects the proposed changes using the manager mode GUI, e.g., FIG. 5. The manager mode GUI is essentially the same for processing proposed changes from both internal and external contributing authors.

FIG. 5 is an example of a manager GUI 410 of one embodiment of the present invention. The manager GUI 410 includes an evolving document window 412, a comparison window 414, and a change summary window 420. The evolving document window 412 shown is for the revision 450 (“Revision as at Dec. 18, 2001 12:51:19”) of the collaboration 448 “Try a Collaboration,” where the word “to” 434 has replaced the word “too” (not shown). The comparison window 414 shows the proposed changes by contributing author Victoria (Victoria tab 416). The proposed changes for contributing author Michael (Michael tab 418) are hidden in this embodiment. In an alternative embodiment Michael's proposed changes are shown in a separate, unhidden window. In comparison window 414 proposed change 432 shows the word “too” struck through, i.e., deleted, and the word “to” double-underlined, i.e., added. By accepting the proposed change 432, replacing the word “too” with “to,” the evolving document window 412 shows the result, i.e., the word “to” 434. A synchronization button 430, causes a portion of the text in the display in the comparison window 414 around a selected proposed change, e.g., 432, to also be shown in the evolving document window 412 around the associated text affected by the proposed change, e.g., the word “to” 434. A revision pull-down menu 422 allows different revisions (and associated responses) to be displayed in the windows of GUI 410. A contribution refresh button 440 updates the manager GUI 410 with the latest response information from the contributing author(s). For example, if a response comes in from a contributing author “Gary,” then, when the refresh button 440 is selected, a tab labeled “Gary” is added along with a new comparison window showing Gary's proposed edits. The change summary window 420 is also updated. A change summary display button 422 toggles the change summary window 420 between visible and hidden.

The change summary window 420 shows a hierarchical change summary tree 448 for a collaboration by person 421, e.g., Michael 452 and Victoria 454. The revision displayed in the evolving document window 412 and the comparison window 414 is revision 450 (“Revision as at Dec. 18, 2001 12:51:19”) with responses Michael 452 and Victoria 454. The responses for Michael 452 and Victoria 454 correspond to the text displayed in tabs 418 for Michael and 416 for Victoria, respectively.

FIG. 6 is an example of a internal contributor GUI 510 of one embodiment of the present invention. The internal contributor GUI 510 includes an edit window 512, a comparison window 514, and a change summary window 520. The edit window 512 is for entering the contributor's proposed changes. For this example, the internal contributor GUI 510 has been opened by a third contributing author “Kim.”

The change summary window 520, and the comparison window 514 generally cover the same content as the manager GUI's change summary window 420, and comparison window 414, except in the internal contributor GUI 510, the change summary window 520, and the comparison window 514 are read-only (indicated by being grayed out). The tabs and associated contents of the comparison windows for tabs 416 and 418 are typically the same for the manager GUI 410 as tabs 520 and 522 for the internal contributor GUI 510, respectively. FIG. 6 has an additional revision 620 (“Revision as at Feb. 25, 2002 3:38:17 PM”), not in FIG. 5, because a new contributing author “Kim” opened the revision 450 (“Revision as at Dec. 18, 2001 12:51:19”) after one or more proposed changes were accepted by the managing author into revision 450. In the example of FIG. 6 revision 620 is revision 450 modified after all the proposed changes of Michael 452 and Victoria 454 have been accepted. The revision 450 is selected, as opposed to revision 620, because a section of the revision 450 hierarchy is selected, e.g., item 454.

There is a synchronization button 518 which operates like, but independently, from the synchronization button 440 of the manager GUI 410. Since the contributor application is reading the same files in the change summary window and the comparison window, as the manager application, the contents of their displays should typically be the same. However, like the manager GUI, the contributor GUI 510 has a refresh or update button 518 which updates the change summary window and the comparison window displays with any new information over what is currently displayed, for example, a third contributor's edits or a second response from Victoria. In one embodiment the refresh buttons, e.g., 518 and 440, for the contributor GUI 510 and manager GUI 410, respectively, operate independently, hence the change summary window and the comparison window for the manager GUI 410 may not show the same updates as the change summary window and the comparison window for contributor GUI 510. In another embodiment the refresh buttons for the contributor GUI 510 and manager GUI 410 are linked together and the change summary window and the comparison window for the manager GUI 410, as well as the same windows for the contributor GUI 510 update together. In a further embodiment the summary window and the comparison window for the manager GUI 410, as well as the same windows for the contributor GUI 510 update automatically.

Thus because the contributing authors have access to the same data repository as the managing author, e.g., the DMS or local file system or collaboration server database, each contributing author can view his/her proposed changes along with the other contributing authors proposed changes via the change summary pane 520 and the comparison pane 514.

The edit window 512 displays the last revision received from the managing author. For example, in this case, revision 450 (“Revision as at Dec. 18, 2001 12:51:19”). The contributing author Kim makes edits (or comments) to a replica of revision 450, which is displayed in edit window 512. When the contributing author Kim is finished making edits, she submits her proposed changes to the managing author.

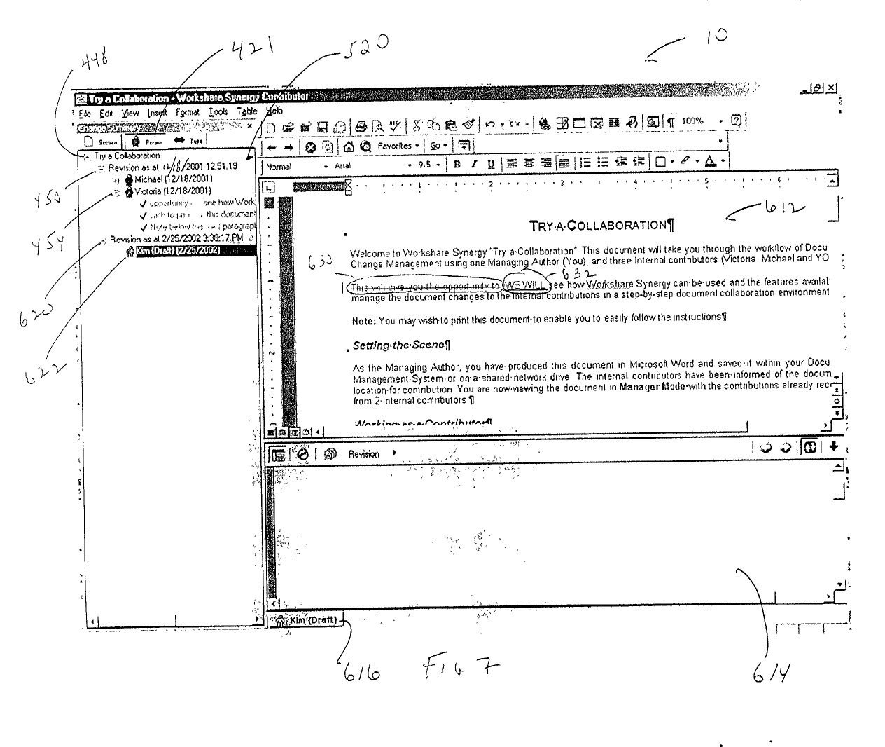

FIG. 7 is another aspect of the internal contributor GUI 510 of FIG. 6. In this case revision 620 (“Revision as at Feb. 25, 2002 3:38:17 PM”) is selected by the selection of item 622 (“Kim{Draft} (Feb. 25, 2002)”). Modifications to revision 620 by contributing author Kim are shown in editing window 612. For example, in edit window 612, item 630 shows the words: “This will give you the opportunity to” deleted (struck-through) by the contributing author, and item 632 shows the words “WE WILL” added (double underlined) by the contributing author. The edited replica has been saved as a draft on the contributing author's computer as indicated by item 622. The draft can be recalled later, edited again, and sent to the managing author. As the mark-up due to the changes is shown in the edit window 612, comparison window 614 is blank for tab 616 (“Kim {draft}”).

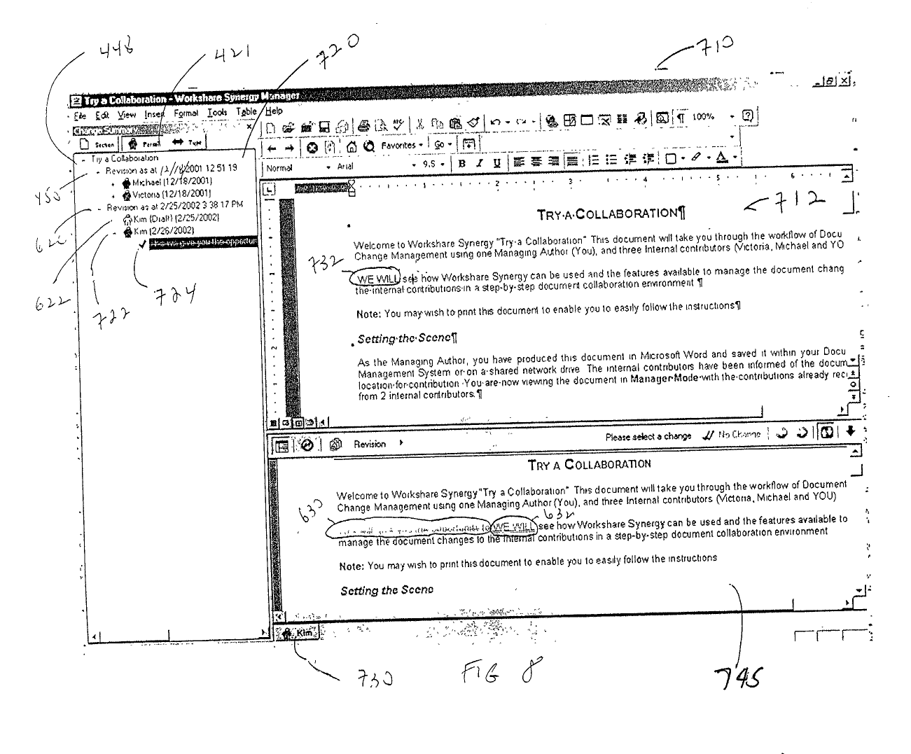

FIG. 8 is another example of a internal contributor GUI of an aspect of the present invention. Manager GUI 710 shows the result, after the proposed changes by contributing author Kim 730 have been received and accepted by the managing author. In the change summary window 720, Kim's response is shown by label 722 (“Kim (Feb. 26, 2002)”). The proposed changes 630 and 632 in the Kim tab 730 comparison window 714 are shown accepted by the manager by the check on label 724 in the change summary window and the faded redline for changes 630 and 632 in the comparison window 714. In the evolving document window 712 only the result, e.g., the words “WE WILL” 732 are displayed.

The displays of FIGS. 6 and 7 allow a contributing author to see the changes being proposed by other contributing authors, when they are using Internal Contributor Mode. a contributing author can use tabs along the bottom of the screen, e.g., Victoria tab 522 or Michael 520, to switch to see work being done by other authors. Only work that has been submitted to the DMS will be visible. A user is aware that others are working on a document at the same time, but will not be able to see the specifics of their proposed changes until they have been submitted to the managing author. Thus users have “almost-live” access to the evolving collaboration within the DMS or collaboration server database.

One embodiment of the present invention includes updating the comparison window and change summary window due to proposed changes from the contributing authors in the case of the managing author (i.e., manager mode), and due to proposed changes from the other contributing authors in the case of each contributing author (i.e., contributor mode). For example, when a person opens a document in manager mode, new updates from the contributing authors are determined and displayed in the comparison window, including new tabs, and in the change summary window. When working in the manager mode, updates are only provided if requested by the managing author. So if a new response arrives, it would not appear in the change summary and comparison windows until the managing author requested an update, for example, by selecting a refresh contribution tab in the file menu. The contributor mode handles the updates the same as or similar to the manager mode. The updates from the other contributors must be requested by the contributing author before his/her GUI is updated, for example, by selecting a refresh contribution tab in the file menu. In one embodiment the contributing author must also request an update for the edit window to display the managing author's accepted or rejected changes from the manager's evolving document window.

An alternative embodiment of the present invention provides a near simultaneous document editing environment. The changes are displayed nearly simultaneously, because as each contributor makes and submits changes, the changes are sent to tabs on the manager GUI. For example, a manager has a word document open in DMS; A contributor goes to DMS and sees a document he/she wants to edit, requests the document, and because document is open to manager, the document is locked and the contributor gets from DMS a replica of the latest version of the locked document. After the contributor edits the replica, the changes are sent directly to the DMS. Since the manager has also a direct connection to the DMS, a message is sent to the manager's GUI to refresh its view, re-query the comparison window tabs, and re-query the change summary tree. A new tab appears on the manager's view with the new contributor's name and a new pane associated with the new tab with the contributor's changes. The tab (an Active X control) will dynamically track future changes, upon submittal by contributor. Hence if an internal contributor sends a new change to the DMS, the manager's tabs will be updated automatically. All other internal contributors will also see the new changes. Thus the concept includes a replica of an original document being changed (and submitted) by a first person and a second (or third, etc.) person gets and makes changes (and submissions) to another replica and the changes then appear on a separate screen, i.e., tab, on the first person's display, i.e., near simultaneous changes are displayed.

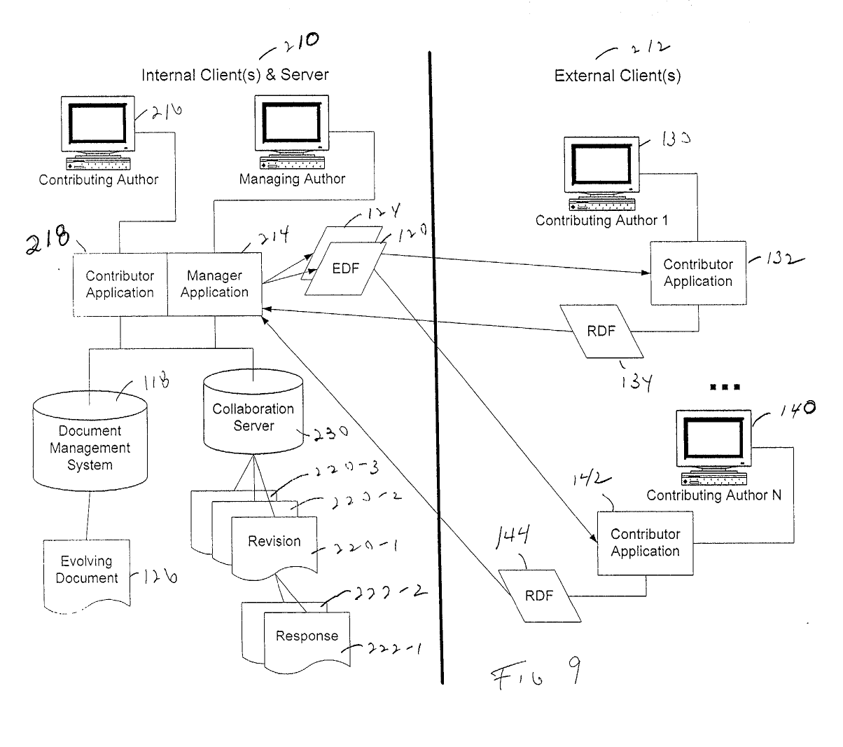

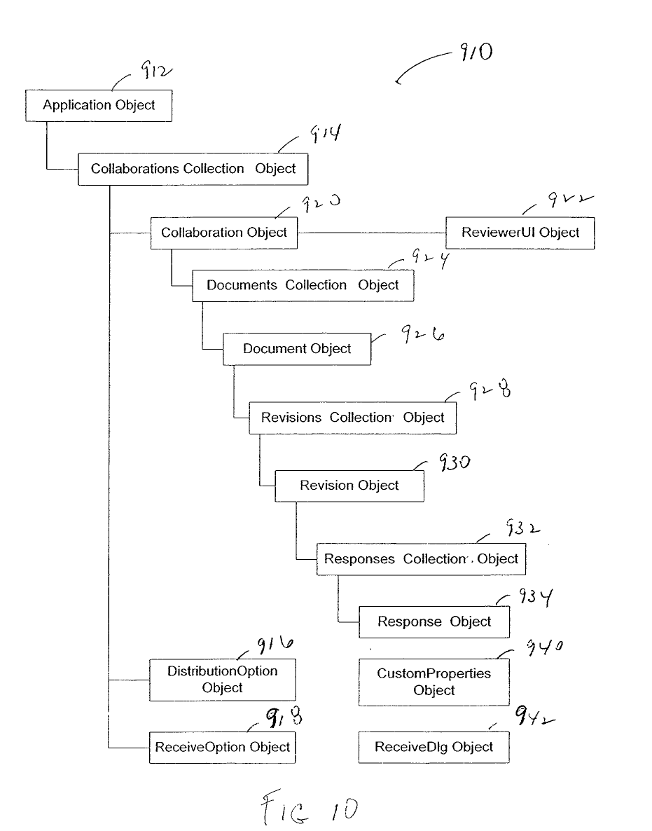

FIG. 9 is simplified block diagram of the document collaboration system of another alternative embodiment of the present invention. FIG. 9 is similar to FIG. 2 except the revisions and responses are maintained in a separate system, i.e., the collaboration server 230 that comprises a database, rather than in the DMS (or local file system). The collaboration server's database is organized in a hierarchical object structure (FIG. 10) and is implemented using an database engine such as that supplied by Objectivity, Inc. of Mountain View, Calif.

FIG. 10 is an object model of an aspect of the present invention. An applications object 912 is the root object. The applications object 912, created by the manager application 214, includes a collaborations collection object 914 having a list of one or more collaborations. A collaboration, represented by collaboration object 920, includes a documents collection object 924, where the documents collections object 924 includes one document, where the document is represented by document object 926. In an alternative embodiment the documents collections object 924 includes one or more documents. A document object 926, is associated with an original document initially selected by the managing author from the DMS or local file system or collaboration server. The document object 926, has a revisions collections object 928, where each revisions collections object 928 has zero or more revisions, e.g., revision object 930. A revision object includes either the original document or a modified original document (i.e., an original document with incorporated changes), i.e., an edited version of the original document as it evolves. Each revision object 930 has a responses collection object 934, where each responses collection object 934 includes zero or more responses, e.g., response object 934. Each response object 934 includes a response from a contributing author.

In an aspect of the present invention an Application Programming Interface (API) is provided to operate on a database having the object model of FIG. 10. The database may be part of a DMS 118, local file system, or collaboration server 230. In one embodiment, Microsoft® Component Object Model (COM) function interfaces are provided for the objects shown in FIG. 10. The COM interfaces are described below for each object of FIG. 10.

The application object 912 provides the entry point to the API. No other object can be accessed or created without first creating an application object. The COM interfaces associated with the application object are:

“ConnectToServer(strBootFilePath As String)” that provides a connection to collaboration store and accepts the file path to the boot file of the server.

“ImportXDF(strCollaborationID As String)” returns the number of collaboration objects in the list.

“Collaborations As Collaborations” returns the collaborations collection object 914.

The collaborations collection object 914 provides access to a list of collaboration objects 920 that are currently open, and adds new collaboration objects. Responses from collaborating authors from any collaboration can be merged at this point giving direct access to the relevant response object 934. The COM interfaces are:

“Add(strCollaborationID As String) As Collaboration” adds an existing collaboration object 920 to the collection 914. This will return the collaboration object 920.

“Count As Long” returns the number of collaborations in the list.

“Item(vItem) As Collaboration” returns the collaboration object requested. This can be accessed by either an index or by the Collaboration Document ID.

“Create(strDocumentID As String, strTitle As String, strCreator As String, varVersionOriginal) As Collaboration” creates a new collaboration based upon an existing document and returns the collaboration object. Note that varVersionOriginal is a BOOLEAN value.

“ReceiveResponse(pIReceiveOptions As IReceiveOptions) As Response” processes the response file and applies the changes to the correct collaboration. Returns the relevant response object 934.

“DistributionOptions As DistributionOptions” returns the DistributionOptions object 916.

“ReceiveOptions As ReceiveOptions” returns the ReceiveOptions object 918.

“LoadExistingCollab(sBaseDocID As String, 1Flags As Long) As Collaboration” loads an existing collaboration in the specified mode of either Contributor or Manager.

Collaboration object 920 provides information about the current collaboration and provides access to the document contained within the current collaboration. In an alternative embodiment, the collaboration object 920 provides access to the one or more documents contained within the current collaboration. All information is stored in memory To persist this information, an explicit call to “Save” must be made. The COM interfaces are:

“Save( )” requests that the collaboration object 920 saves a snapshot of the data to disk. If the collaboration document is stored in a Document Management System (DMS), it is saved back to the server.

“Close( )” requests the collaboration object 920 shut down and release any resources held. If the collaboration document is stored in a DMS, it is released without saving.

“Title As String” gives the name of the collaboration for display purposes.

“CollabDocID As String” gives the Document ID of the collaboration.

“CreationDate As Double” gives the date the collaboration was created.

“Creator As String” gives the creator or owner of the collaboration.

“Documents As Documents” returns the documents collection object 924.

“CustomProperties As Object” returns the CustomProperties object 940 for this object.

“ReviewerUI As Object” returns the ReviewUI object 922.

“Refresh( )” refreshes collaboration content.

Document Collection Object 924 provides a list of document(s) that are contained within the current collaboration. The COM interfaces are:

“Add(strTitle As String, strDocumentID As String, varVersionOriginal) As Document” adds a new document to the collection. A new revision object 930 will be created. The document object 926 will be returned. Note that varVersionOriginal is a BOOLEAN value, which indicates if a new version should be created in the DMS or not. In the case of a Local File, this value is ignored. In the preferred embodiment only one document can be added to a collaboration. In an alternative embodiment more than one document can be added to a collaboration.

“Count As Long” returns the number of documents in the collaboration. For the preferred embodiment the number returned is either be 0 or 1. In an alternative embodiment the number of documents in the collaboration may be any Natural number.

“Item(varIndex) As Document” returns the document object 926 requested. This can be accessed by either an index or by the original Document ID.

“Remove(pDocument As Document)” removes the document from the list.

Document object 926 provides details about the current document within the collaboration. It is possible to publish a document to create a new revision from this object. The COM interfaces are:

“BaseDocumentID As String” returns the original Document ID of the document it was initially created from.

“Title As String” give the title of the document for display purposes.

“Revisions As Revisions” returns the revisions collection object 928.

“Collaboration As Collaboration” returns the collaboration object 920 that the document is contained within.

“CustomProperties As Object” returns the CustomProperties object 940 for this object.

“LatestRevision As String” returns the latest revision of the document in the collaboration.

“CreateNewRevision(strVersionTitle As String) As Revision” creates a new revision of the document in the collaboration and returns the revision object 930.

Revisions Collection Object 928 provides a list of revisions for the document within the collaboration. The COM interfaces are:

“Count As Long” returns the number of revisions in the list.

“Item(lIndex) As Revision” returns the revision object 930 requested. This can be accessed by either an index or by title of the revision object.

Revision object 930 provides details about the revision of the current document in the collaboration. This object allows distribution of the file by email or creation of the file for editing by members of the collaboration The COM interfaces are:

“Title As String” gives the title of the revision for display purposes.

“Document As Document” returns the document object 926 that the revision is contained within.

“Responses As Responses” returns the collection of responses relating to this revision of the collaboration.

“CustomProperties As Object” returns the CustomProperties object 940 for this object.

“CreateDistributionFile(pOptions As DistributionOptions, strFileName As String) As String)” creates a distribution file ready for members to edit, based on the options chosen in the DistributionOptions object 916. The file is generated in the location specified by the strFileName path.

“DistributeFile(pOptions As DistributionOptions, strSubject As String, strBody As String, varEmailAddressList) As String” creates a distribution file as above and emails the file to the list of selected people.

“get_CreationDate As Double” returns the creation date for this revision.

“OriginalFile As String” returns a reference to the local copy of the version of the distribution file.

Responses Collection Object 932 provides a list of responses for the current revision of the collaboration. The COM interfaces are:

“Count As Long” returns the number of responses in the collection.

“Item(1Index) As Response” returns the response object 934 requested. This can be accessed by either an id or by a name (title of the response).

“AddDummyResponse(oReceiveOptions as ReceiveOptions) As Response” adds a dummy response to the collection.

Response object 934 provides details of the responses from a member of the collaboration. The COM interfaces are:

“Title As String” gives the name of the person that submitted the response file for display purposes.

“Color As Long” gives the assigned color of the person that submitted the Response for display purposes.

“ReceivedDate As Double” gives the date the response was received.

“EMailFrom As String” gives the name of the person the response was received from.

“EmailAddress As String” gives the email address of the person the response was received from.

“Revision As Revision” returns the Revision object 934 that the response is contained within.

“CustomProperties As Object” returns the CustomProperties object 940 for this object.

“CommentsBuffer As String” returns the comments supplied by the response.

CustomProperties object 940 provides a list of custom properties relating to an object. The COM interfaces are:

“SetProperty(strKey as String, varValue as Variant)” sets/creates a property.

“GetProperty(strKey as String)” gets a property and returns the property value.

DistributionOptions object 916 provides details for distribution of a collaboration revision. The COM interfaces are:

“FileFormat As Long” specifies the format of the file to be created (can be either RTF or Contributor file format). See Table 1 below:

TABLE 1

| Format | Enumerator | Value |
|---|---|---|
| EDF | fmtWS | −1 |
| MS Word Document | fmtDOC | 0 |
| Text | fmtTXT | 2 |
| RTF | fmtRTF | 6 |
| HTML | fmtHTML | 8 |

“Password As String” specifies the password to encrypt the document with.

“Compress As Boolean” specifies whether the file should be compressed (applies to RTF file format only—compression is achieved using WinZIP).

“ReturnType As Long” specifies how the response file should be returned (see Table 2).

TABLE 2

| Format | Enumerator | Value |
|---|---|---|
| No Default Return Type | wsReturnNone | 0 |
| Return to Email Recipient | wsReturnToEmail | 3 |
| Return to Email Recipient* | wsForceRetumToEmail | 4 |

“ReturnAddress As String” specifies where the response file should be returned.

“EDFExpiryDate As String” specifies the date when an EDF will expire. If no date is specified then the EDF will never expire.

“Disable_Edit_Docs As Long” specifies the editing rights for the EDF document. A value of 1 will restrict the EDF document from editing. A default of 0 will allow editing of the EDF.

“Disable_Export As Long” specifies the export rights for an EDF document. A value of 1 will restrict any copying out or printing of the document. A default of 0 will allow all exporting rights of an EDF.

“CustomProperties As Object” returns the CustomProperties object 940 for this object.

ReceiveDlg object 918 processes response files received for inclusion in a collaboration. The COM interfaces are:

“ReadFile(strLocalPath As String) As IReceiveOptions” reads a response file and creates a ReceiveOptions Object 918 for insertion of the response into its corresponding collaboration.

“ShowDialog(lhWndParent as Long, strFileName as String) as Long” displays the receive module with the selected RDF file.

“ShowDialogForImport(lhWndParent as Long, strCollaborationDocID as String, strLocalPath as String) as Long” displays the receive module for importing a response document into a collaboration. The path to the collaboration and the path to the response document are required.

“ImportDocument(strCollaborationDocID as String, strLocalPath as String, strRevisionName as String, ByRef pReceiveOptions as ReceiveOptions)” imports a document into a collaboration. The path to the collaboration, path to the response document and the name of the revision to import into are required. A ReceiveOptions object 918 is returned object for insertion of the response into its corresponding collaboration.

ReceiveOptions object 918 provides details for receiving of a response file. This is returned by the Receive application. The COM interfaces are:

“Title As String” specifies the title for the response.

“SenderName As String” specifies the senders name for the response.

“SenderAddress As String” specifies the senders email address for the response.

“Color As Long” specifies the color for the response.

The specification and drawings are, accordingly, to be regarded in an illustrative rather than a restrictive sense. It will, however, be evident that additions, subtractions, deletions, and other modifications and changes may be made thereunto without departing from the broader spirit and scope of the invention as set forth in the claims.

What is claimed is:

1. A method using a computer system for collaboration on a document stored in a computer readable medium, between a managing author and a contributing author, comprising:
assigning computer access rights to said document by said managing author, said computer access rights exclusively controlling changes to said document;
creating a replica of said document using said computer system, when said contributing author accesses said document for editing;
causing a change to said replica, when said contributing author edits said replica; and
incorporating said change into said document, if said change is accepted by said managing author.

2. The method of claim 1 wherein said replica is stored in said computer readable medium.

3. The method of claim 2 wherein said computer readable medium is a common database accessible by both said managing author and said contributing author.

4. The method of claim 1 wherein said document is a word processing document.

5. The method of claim 4 wherein said word processing document is a Microsoft® Word document.

6. A system for document collaboration between a plurality of user computers linked via a communications network, comprising:
a common storage area coupled to said plurality of user computers via said communications network;
manager software stored on a first user computer of said plurality of user computers, said manager software for exclusively controlling change to a document stored in said common storage area; and
contributor software stored on a second user computer of said plurality of user computers, said contributor software providing a proposed change to a replica of said document, said replica stored in said common storage area.

7. The system of claim 6 wherein said proposed change is incorporated into said document by said manager software.

8. The system of claim 7 wherein said common storage includes a revision comprising said incorporated proposed change to said document.

9. The system of claim 6 wherein said common storage area is a Document Management System (DMS).

10. The system of claim 9 wherein said DMS comprises a response comprising said proposed change.

11. The system of claim 6 wherein said document is an evolving document.

12. The system of claim 6 wherein said common storage area is part of a local file system.

13. The system of claim 6 wherein said common storage area is part of a collaboration server.

14. The system of claim 6 wherein said manager software and said contributor software are part of a single executable program.

15. The system of claim 6 wherein said common storage area comprises a revision object, said revision object having a response object.

16. A method for document collaboration using a contributor computer and a manager computer connected together via a network, said method comprising:
said contributor computer receiving a replica of a document sent by said manager computer, wherein said replica and said document are stored in a common database;
generating a proposed change by editing said replica; and
displaying by said contributor computer of a portion of said document having said proposed change, after said proposed change is incorporated by said manager computer into said document.

17. The method of claim 16 wherein said common database is database selected from a group consisting of a DMS, a collaboration server database, and a flat file.

18. The method of claim 16 wherein said portion of said document having said proposed change being displayed is part of a next revision of said document.

19. A method for document collaboration using a plurality of contributing computers and a managing computer, said manager computer controlling changes to a document, said method comprising:
displaying a part of a first replica of said document by a first computer of said plurality of contributing computers; and
concurrently with said displaying said part of said first replica, said first computer displaying a part of a second replica of said document, wherein said second replica comprises a change to said document by a second computer of said plurality of contributing computers.

20. The method claim 19 further comprising sending a change to said first replica by said first computer to said manager computer for changing said document.

21. The method claim 19 wherein said document and said replica is stored in a common data storage area.

22. The method claim 19 wherein said first computer reads a common data storage area comprising said first replica and second replica.

23. The method claim 22 wherein said common data storage area comprises a DMS.

24. The method claim 22 wherein said common data storage area comprises a collaboration server.

25. A system for document collaboration comprising:
a computer storage area; and
a software application stored in a computer readable medium, executing on a computer connected to said computer storage area, said software application comprising a manager mode for controlling changes to a document stored in said computer storage area and a contributor mode for providing a proposed change to a replica of said document, said replica stored in said computer storage area.

26. The system of claim 25 wherein said manager mode exclusively determines if said proposed change is accepted for incorporation into said document.

27. The system of claim 25 wherein said document is a word processing document.

28. A system for document collaboration between a first contributing computer, a second contributing computer, and a managing computer, comprising:
a database coupled to said second contributing computer, said database storing a document, a first replica of said document, and a second replica of said document, wherein said first replica comprises an edit from said first contributing computer; and
a display of said second contributing computer comprising a first window comprising said edit and a second window comprising a part of said second replica.

29. The system of claim 28 further comprising a contributor application stored on said second contributing computer for editing said second replica.

30. The system of claim 28 wherein said display further comprises a change summary window displaying said edit.

31. The system of claim 30 wherein said display further comprises a control to hide said change summary window.

32. The system of claim 28 wherein said first window displays said edit using a redlined format.

33. The system of claim 28 wherein said display further comprises a refresh control to add a third window to said display when a third replica of said document is edited by a third contributing computer.

34. The system of claim 33 wherein said first window and said third window are tabbed.

35. The system of claim 28 wherein a third window is automatically added to said display, when edits to a third replica of said document by a third contributing computer are submitted to said managing computer.

36. The system of claim 28 wherein said display further comprises a synchronization control for aligning said edit in said first window with corresponding text in said second window.

37. The system of claim 28 wherein said second contributing computer can only view, but not change, said first replica.

38. A system for document collaboration between a managing author and a contributing author, comprising:
an application program stored in a computer readable medium comprising:
code for creating a replica of an original document for use by said contributing author;
code for receiving a response, comprising proposed changes to said replica, from said contributing author; and
code for incorporating said proposed changes into said original document, when accepted by said managing author; and
a database, connected to said computer readable medium, for storing said original document, said replica, and said response.

39. The system of claim 38 wherein said replica remains in said database during editing by said contributing author.

40. The system of claim 38 wherein said database in a DMS.

41. The system of claim 38 wherein said database is an objected oriented database that is part of a collaboration server.

42. A data structure stored in a computer readable medium for maintaining proposed and accepted changes to an original document in a document collaboration between a managing author and one or more contributing authors, said data structure comprising:
a document object associated with said original document;
a revisions collection object associated with said document object, said revisions collection object, comprising one or revision objects, wherein a revision object comprises a revision sent to a contributing author for review; and
a responses collection object associated with said revision object, said responses collection object, comprising one or response objects, wherein a response object comprises a response having proposed changes to said revision from said contributing author.

43. The data structure of 42 further comprising a collaboration object, wherein said collaboration object comprises said document object.

44. A method for collaboration between a plurality of contributing authors and a managing author using a common database, comprising:
said managing author providing a document for review by said plurality of contributing authors;
a first contributing author of said plurality of contributing authors storing a first proposed change to said document in said common database;
a second contributing author of said plurality of contributing authors storing a second proposed change to said document in said common database;
displaying on a display used by said first contributing author said second proposed change; and
displaying on a display used by said second contributing author said first proposed change.

45. The method of claim 44 wherein said displaying on said display at said first contributing author and said displaying on said display at said second contributing author is performed concurrently.

46. The method of claim 44 further comprising displaying on a display at said managing author said first proposed change and said second proposed change.

47. A computer-readable medium containing instructions for causing a computer system to provide an application with an interface for manipulating objects in a database, said database used for document collaboration, said instructions comprising:
adding a revision object when a document is added to said document collaboration;
distributing for review by a contributing author a replica of said document; and
associating a response object with said revision object based on a response received from said contributing author.

48. The instructions of claim 47 further comprising creating another revision of said document for review by another contributing author.
